(19) United States
(12) Patent Application Publication
(10) Pub. No.: US 2010/0239388 A1
(43) Pub. Date: Sep. 23, 2010

(54) Plate-shaped fastener device

(76) Inventor: Chun I. Yao, Taichung (TW)

Correspondence Address: CHARLES E. BAXLEY, ESQUIRE, 90 JOHN STREET, SUITE 309, NEW YORK, NY, 10038, US

(21) Appl. No.: 12/383,010

(22) Filed: Mar. 19, 2009

(51) Int. Cl. F16B 15/00

(52) U.S. Cl. 411/477

(57) ABSTRACT

A fastener device includes a fastener member having a planar element and having a cutting member for engaging into a board, and one or more teeth formed on the planar element, one or more reinforcing ribs extended from the planar element for reinforcing the planar element, and a head formed on top of the planar element for being engaged with driving tools and for limiting the engagement of the fastener member into the board. The planar element may include two panels foldable relative to an intermediate board for forming the head and for forming a two-layer structure for the head, and may include one or two longitudinal members extended from the panels.

### BACKGROUND OF THE INVENTION

1. Field of the Invention

The present invention relates to a plate-shaped fastener device, and more particularly to a plate-shaped fastener device for engaging with the boards, wood or metal panels or the like and for attaching or securing boards together or for attaching or securing boards to the other supporting objects or walls and for preventing the fastener device from being disengaged from the boards and/or the supporting objects or walls.

2. Description of the Prior Art

Typical plasterboards, wood or metal panels or the like have been developed and provided for building construction purposes, and the plasterboards, the wood or metal panels or plates or the like are required to be secured together or required to be secured to the other supporting objects or walls with various kinds of fastener devices or fastener strips or the like.

For example, U.S. Pat. No. 3,511,127 to Gisondi discloses one of the typical metal fastening devices comprising an elongated blank of sheet metal stamped out in the form of an elongated strip, a series of teeth or jagged surfaces are formed on the side portions of the blank for engaging with the boards, the panels or the like that are required to be secured to the other supporting objects or walls, and the blank includes a head end bent from the topmost portion along a fold line.

However, the blank is made of a single sheet metal that is required to be heat treated in order to increase the stiffness or strength of the blank, and the head end has only a partial superposed portion, and the head end may have a good chance to be broken or bent relative to the blank.

U.S. Pat. No. 3,882,755 to Enstrom discloses another typical sheet metal drive fastener for penetrating roofing insulation and the like and puncturing sheet steel of other sheet metal decking and interlocking with the decking for securing the insulation thereto, and including two wings extended outwardly from opposite side portions in divergent relation to the adjacent edges of the shank, and including laterally extended lugs to form the fastener head to be driven.

However, similarly, the sheet steel is also a single sheet metal that includes a thin layer and that is required to be heat treated in order to increase the stiffness or strength of the blank, and the fastener head is also a single sheet metal that has a decreased stiffness or strength.

U.S. Pat. No. 6,139,238 to Anstett, and U.S. Pat. No. 7,033,122 to Farrell et al. disclose two further typical plate-shaped fastener for securing a member or instrument to a wall or board, and comprising a head member laterally extended from the plate-shaped fastener.

However, similarly, the fasteners are also made of a single sheet metal that includes a thin layer and that is required to be heat treated in order to increase the stiffness or strength of the fastener, and the fastener head is also a bent single sheet metal that has a reduced or decreased stiffness or strength.

The present invention has arisen to mitigate and/or obviate the afore-described disadvantages of the conventional fastener devices for plasterboards.

### SUMMARY OF THE INVENTION

The primary objective of the present invention is to provide a plate-shaped fastener device for engaging with the boards and for attaching or securing boards together or for attaching or securing boards to the other supporting objects or walls and for preventing the fastener device from being disengaged from the boards and/or the supporting objects or walls and for preventing the boards from being broken by the fastener device.

The other objective of the present invention is to provide a plate-shaped fastener device including a reinforcing structure that may be easily and quickly manufactured.

In accordance with one aspect of the invention, there is provided a fastener device comprising a fastener member including a planar element having a cutting member provided on a lower portion thereof, and including a head provided on top of the planar element, and the planar element being formed with a planar member which includes an intermediate board having a shape corresponding to that of the head, and which includes two panels oppositely extended from the intermediate board and foldable relative to the intermediate board for engaging with the intermediate board and for forming the head of the planar element and for reinforcing the head of the planar element, and which includes a longitudinal member extended from a first panel or one of the panels.

The planar member includes a second longitudinal member extended from a second panel of the panels. The planar element includes at least one coupling member extended from one side of the second longitudinal member of the planar member.

The planar element includes at least one coupling member extended from one side thereof. A second fastener member may further be provided and may include a second planar element having a cutting member provided on a lower portion thereof, and including a head provided on top of the planar element, and may include at least one second coupling member extended from one side of the second planar element and detachably coupled to the coupling member of the planar element.

A folding line may be formed between the coupling member of the planar element and the second coupling member of the second planar element for allowing the fastener members to be detachably coupled together and to be selectively cut off or separated from each other and for allowing the fastener members to be effectively driven or engaged into or through the boards or plates.

The panels each include a shape corresponding to one half of the intermediate board or of the head. The fastener member includes a plurality of teeth extended from side portions of the planar element for anchoring purposes. The teeth are preferably the ratchet teeth.

The fastener member includes one or more reinforcing ribs extended from the longitudinal member of the planar member for reinforcing purposes. The planar element includes at least one coupling member extended from one side of the longitudinal member of the planar member for coupling the planar member or the planar elements together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating the fastener members of a fastener device in accordance with the present invention;

FIG. 2 is a partial cross sectional view of the fastener member taken along lines 2-2 of FIG. 1;

FIG. 3 is a perspective view illustrating one of the fastener members of the fastener device;

FIG. 4 is a plan schematic view illustrating a planar member for manufacturing the fastener member;

FIG. 5 is another perspective view similar to FIG. 3 illustrating the other arrangement of the fastener member;

FIG. 6 is a plan schematic view illustrating the planar member for manufacturing the fastener member as shown in FIG. 5;

FIGS. 7, 8, 9, 10, 11, 12, 13 are plan schematic views similar to FIGS. 4 and 6 illustrating the further arrangement of the planar member for manufacturing the fastener member;

FIGS. 14, 15 are plan schematic views similar to FIG. 1 illustrating the operation of the fastener device;

FIG. 16 is a further plan schematic view similar to FIGS. 4, and 6-13 illustrating the still further arrangement of the planar member for manufacturing the fastener member;

FIG. 17 is a further plan schematic view of the fastener member as shown in FIG. 16;

FIG. 18 is a side plan schematic view of the fastener member as shown in FIG. 17;

FIGS. 19, 21, 23 are plan schematic views similar to FIG. 17 illustrating the still further arrangement of the fastener member; and

FIGS. 20, 22, 24 are side plan schematic views of the fastener member as shown in FIGS. 19, 21, 23 respectively.

### DETAILED DESCRIPTION OF THE PREFERRED EMBODIMENT

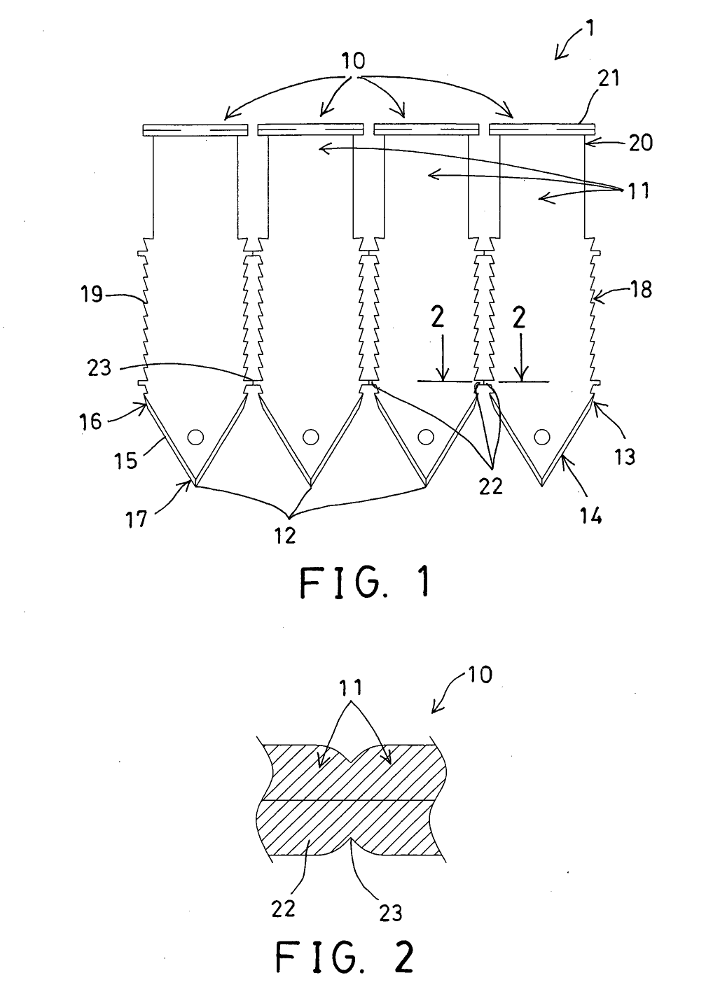

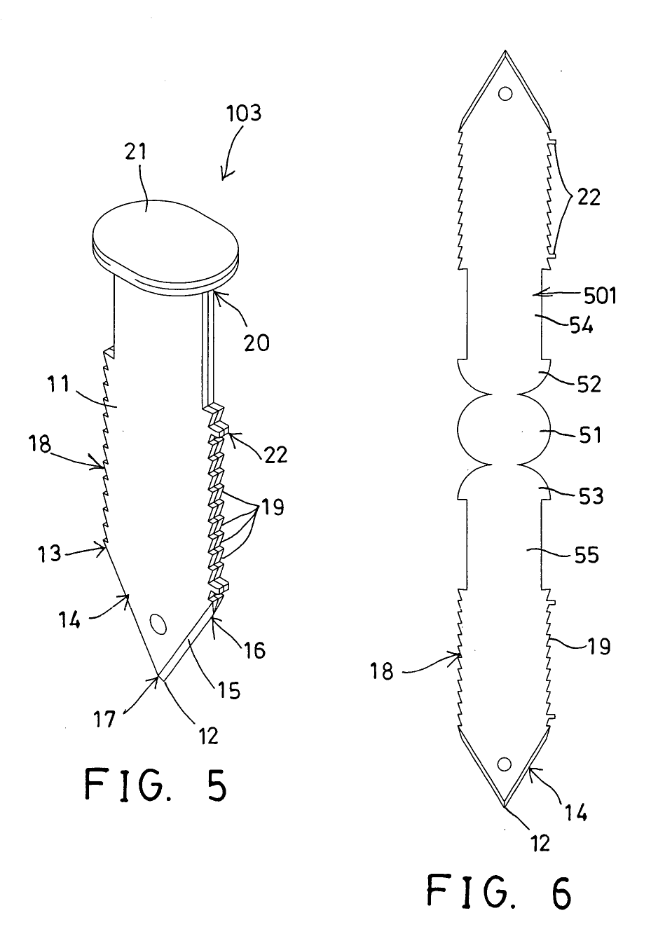

Referring to the drawings, and initially to FIGS. 1-3, a fastener device 1 in accordance with the present invention comprises a number of fastener members 10 held or supported or coupled or secured together with one or more holding or supporting strips (not shown) or with coupling members which will be discussed hereinafter. As shown in FIGS. 1 and 3, the fastener members 10 each include a planar body or plate or element 11 having a tip 12 extended from the lower portion 13 thereof for easily engaging into one or more boards, wood or metal panels or plates or the like (not shown) for attaching or securing the boards, wood or metal panels or the like together or for attaching or securing the boards, wood or metal panels or the like to the other supporting objects or walls (not shown), and for preventing the boards from being broken by the fastener members 10 of the fastener device 1.

The fastener members 10 each further include a cutting portion or member 14 formed or provided in the lower portion 13 thereof and located between the planar element 11 and the tip 12 of the fastener member 10. The cutting member 14 includes one or more cutting edges 15 formed or provided therein for further facilitating the engagement of the fastener members 10 into the boards or plates, and for further preventing the boards or plates from being broken by the fastener members 10 of the fastener device. It is preferable that the cutting member 14 of the fastener member 10 includes a wider upper portion 16 adjacent or abutting the fastener member 10 or located closer to the fastener member 10, and includes a narrower lower portion 17 adjacent or abutting the tip 12 or located closer to the tip 12 for allowing the cutting member 14 of the fastener member 10 to be formed as a triangular shape or wedge-shape and for further facilitating the engagement of the fastener members 10 into or through the boards or plates.

The fastener member 10 further includes an anchoring means or device 18 formed or provided on the side portion thereof and having one or more teeth 19, such as ratchet teeth 19 provided on or extended from the side portion of the fastener member 10 for engaging with the boards or plates after the fastener member 10 has been engaged into or through the boards or plates, and thus for anchoring or securing the fastener member 10 to the boards or plates and for preventing the fastener member 10 from being disengaged from the boards or plates. The fastener member 10 further includes an upper portion 20 having a head 21 bent or secured to the planar element 11 of the fastener member 10. The heads 21 are preferably arranged perpendicular to the planar element 11 of the fastener members 10 for engaging with the boards or plates and for limiting the movement or the engagement of the fastener members 10 into or through the boards or plates and for preventing the fastener member 10 from being completely engaged into or through the boards or plates.

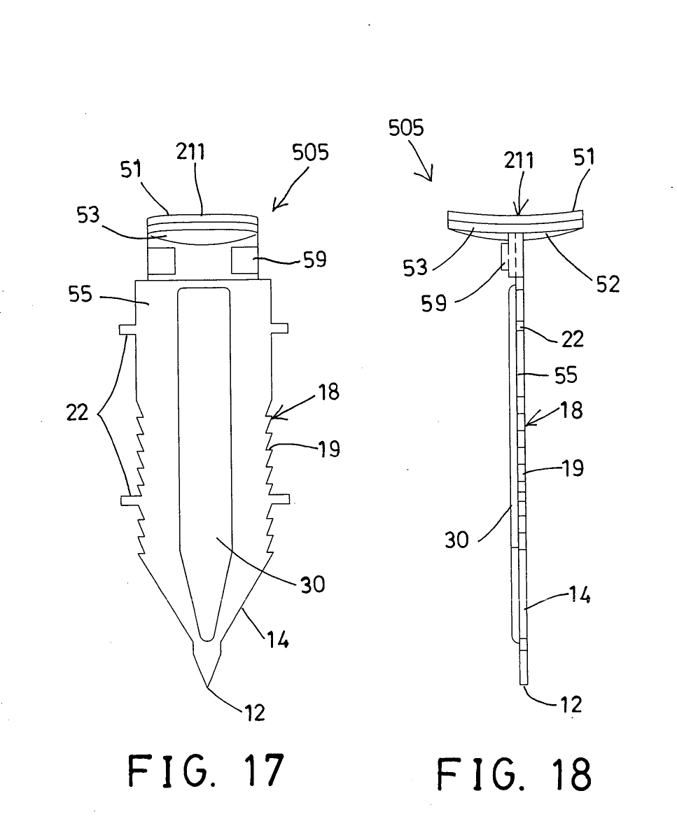

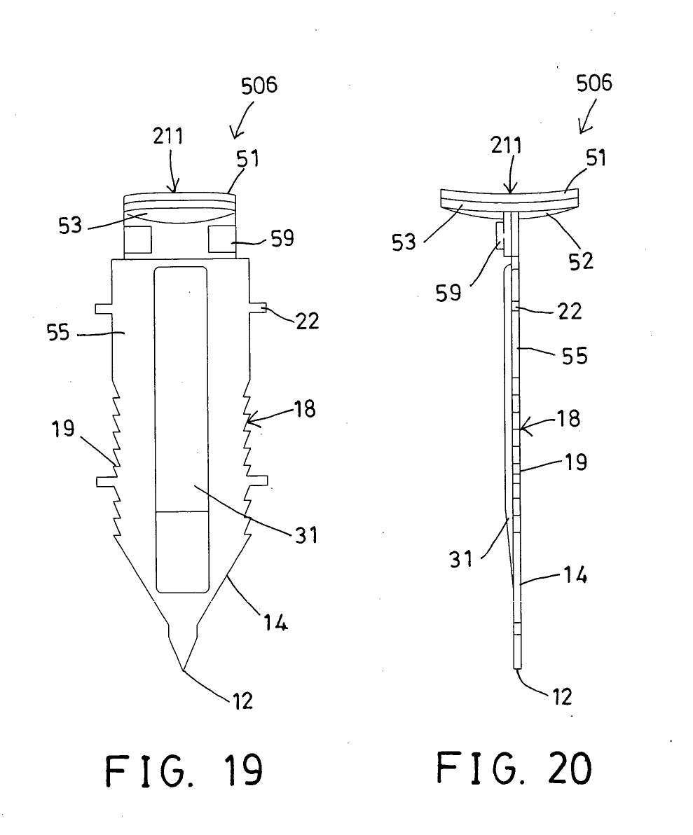

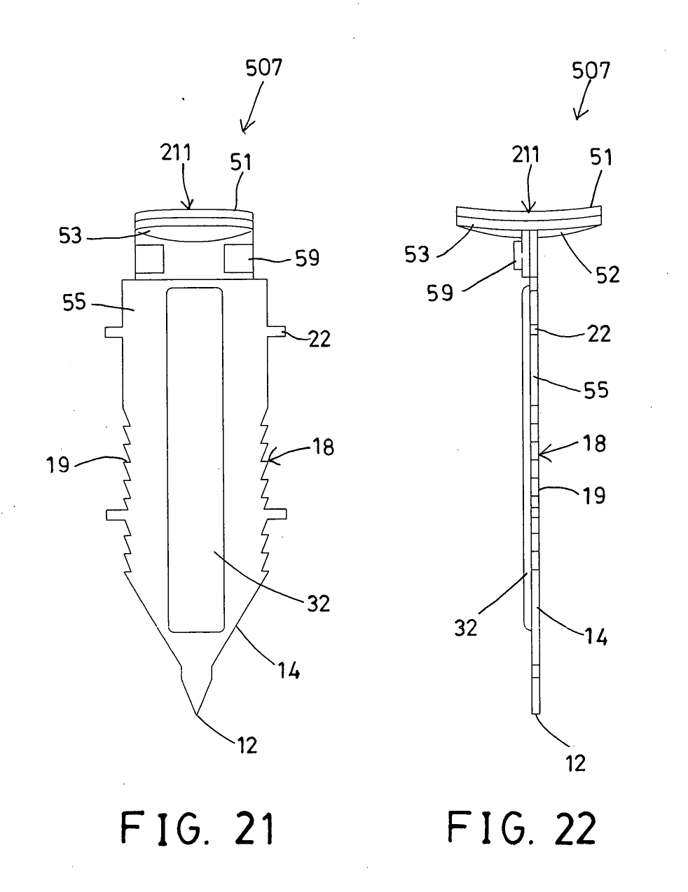

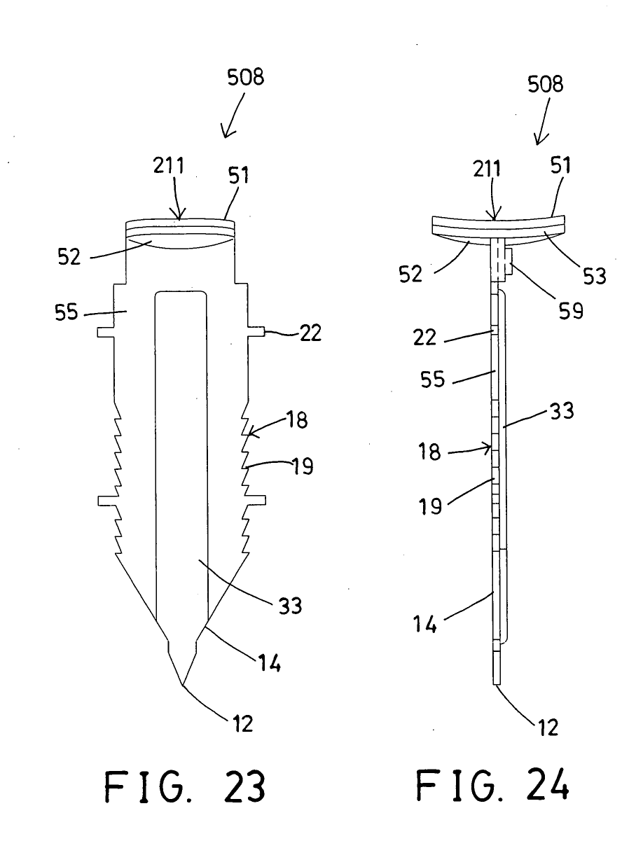

For example, the heads 21 of the fastener members 10 may include a flat or planar structure (FIGS. 1, 3, 5), or the heads 211 may include an upwardly curved structure, or a recessed or downwardly curved structure (FIGS. 17-24), and the heads 21 are arranged for such as centering purposes, or for facilitating the driving or the engagement of the fastener members 10 into or through the boards or plates, or for allowing the fastener member 10 to be easily driven or hammered by the hammering or driving tools (not shown). The fastener members 10 each may further include one or more (such as two) coupling members 22 laterally extended from each of the side portions thereof for coupling to the coupling members 22 of the other fastener members 10, and thus for coupling to the fastener members 10 together.

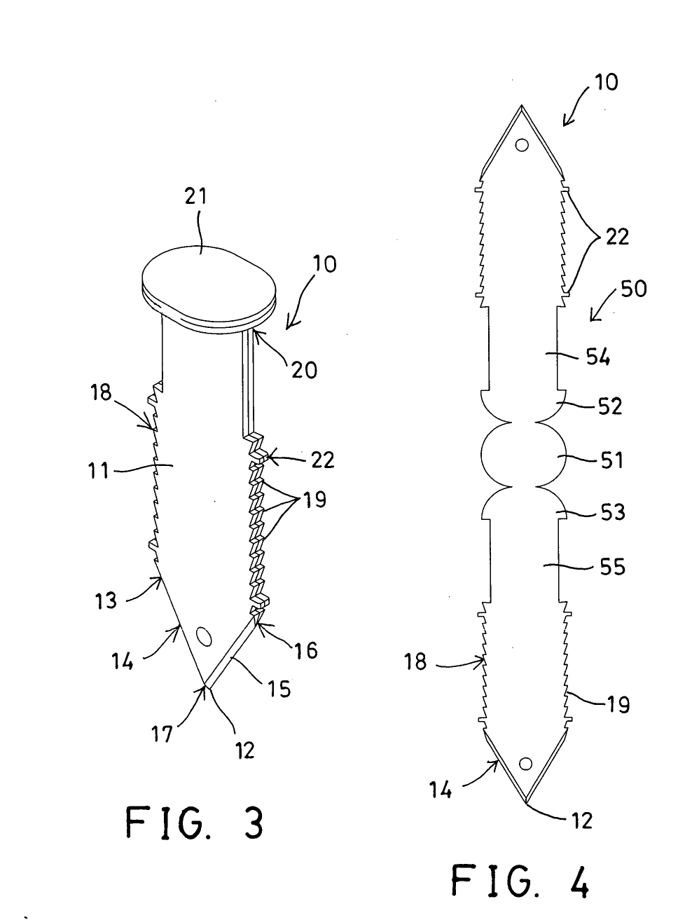

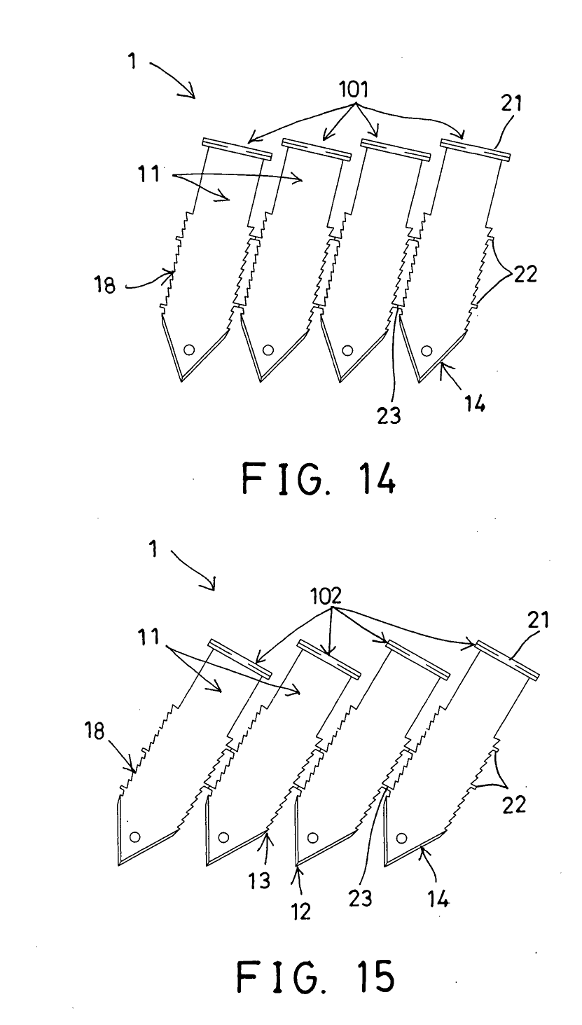

A punching or cutting or folding line 23 (FIGS. 1, 2) may be formed between the coupling members 22 of any two adjacent fastener members 10 for allowing the fastener members 10 to be detachably coupled together and to be selectively cut off or separated from each other and for allowing the fastener members 10 to be effectively driven or engaged into or through the boards or plates. As shown in FIG. 1, the fastener members 10 may be coupled together and arranged parallel to each other for allowing the heads 21 to be aligned with each other in a line. Alternatively, as shown in FIGS. 14 and 15, the fastener members 101, 102 may also be coupled together with the coupling members 22 and also arranged parallel to each other, but tilted or inclined relative to the longitudinal direction or axis of the fastener device 1.

It is to be noted that the provision of the tip 12 and/or the cutting member 14 allows the fastener member 10 to be easily driven or hammered into or through the boards or plates by the driving tools and may prevent the boards or plates from being broken by the fastener device. The anchoring means or device 18 of the fastener member 10 may anchor or secure the fastener member 10 to the boards or plates and may prevent the fastener member 10 from being disengaged from the boards or plates. The coupling members 22 may temporarily or detachably couple the fastener members 10 together for allowing the fastener members 10 t be temporarily or detachably coupled together without the typical holding or supporting strips.

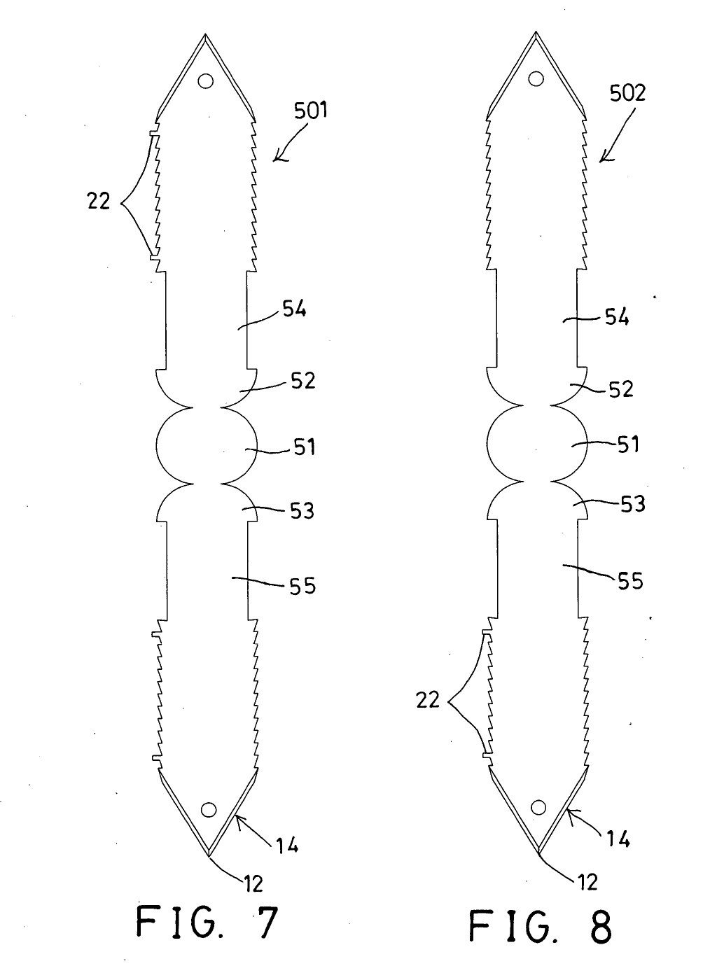

As shown in FIG. 4, the fastener member 10 may be formed or made or manufactured from a planar member 50 or may comprise a planar member 50 which includes a middle or intermediate board 51 having a shape similar to or corresponding to that of the heads 21, two panels 52, 53 oppositely extended from or coupled to two ends or sides of the intermediate board 51 and to be folded relative to the intermediate board 51 for engaging with the bottom portion of the intermediate board 51, and two longitudinal members 54, 55 extended from or coupled to the panels 52, 53 respectively and to be folded relative to each other and to be secured together with such as forging, beating, or hammering and/or adhering or welding procedures. The teeth 19 of the anchoring means or device 18 and the coupling members 22 may be punched or formed in the planar member 50 when the planar member 50 is formed or made or manufactured or shaped.

The fastener element 10 may thus include two longitudinal members 54, 55 having the identical shape and secured together to form the planar element 11 of the fastener members 10, and may include an intermediate board 51 and two panels 52, 53 forged or hammered and secured together for forming a reinforcing structure, and the two panels 52, 53 each may include a shape corresponding to a portion of the intermediate board 51, such as one half of the intermediate board 51, and the two panels 52, 53 may be formed into the shape of the intermediate board 51 after the panels 52, 53 are folded relative to the intermediate board 51 and engaged with the bottom portion of the intermediate board 51 and secured to the bottom portion of the intermediate board 51 with the forging, beating, or hammering and/or adhering or welding procedures, for forming a two-layer structure.

It is to be noted that, while forging, beating, or hammering the planar member 50 into the fastener member 10, the recessed or downwardly curved structure or the upwardly curved structure or the flat or planar structure of the heads 21 and/or the cutting edges 15 of the cutting member 14 may be formed or made or manufactured or shaped simultaneously, and the heads 21 may be directly formed and shaped on top of the planar element 11 of the fastener members 10 without additional assembling procedures, the planar element 11 may include two longitudinal members 54, 55 directly forged or hammered and secured together for increasing the strength of the planar element 11 of the fastener members 10. The cutting edges 15 of the cutting member 14 may also be formed or made or manufactured or shaped after the intermediate board 51 and the panels 52, 53 and the longitudinal members 54, 55 have been folded and formed into the fastener members 10.

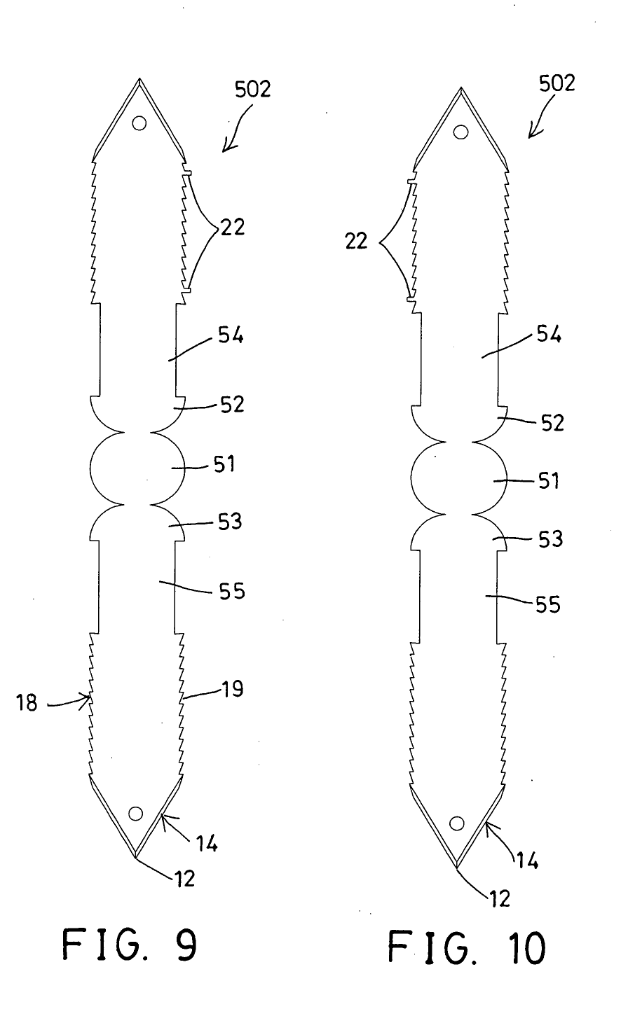

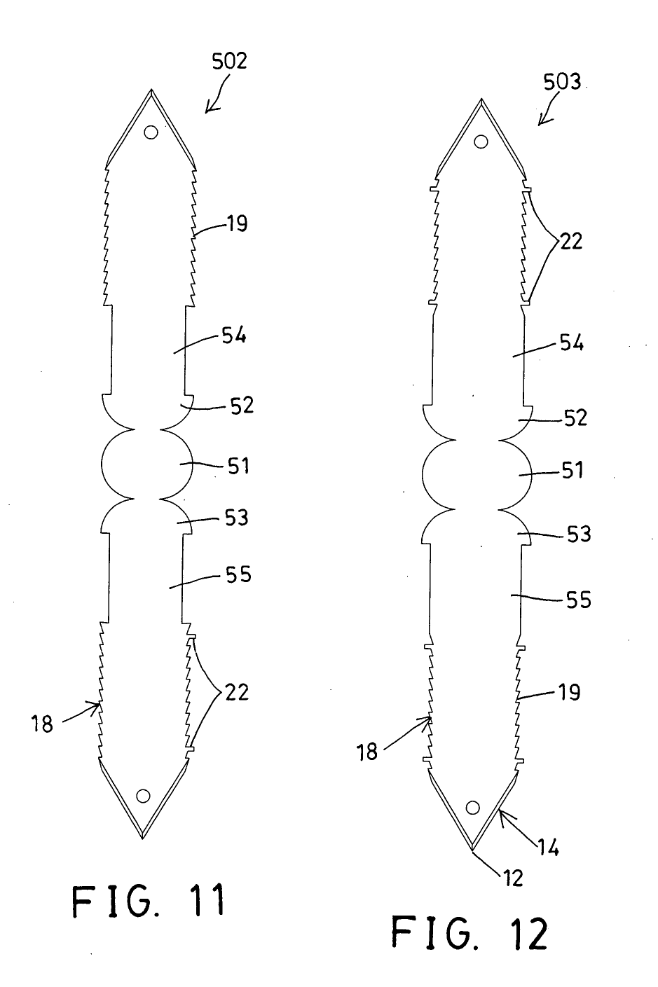

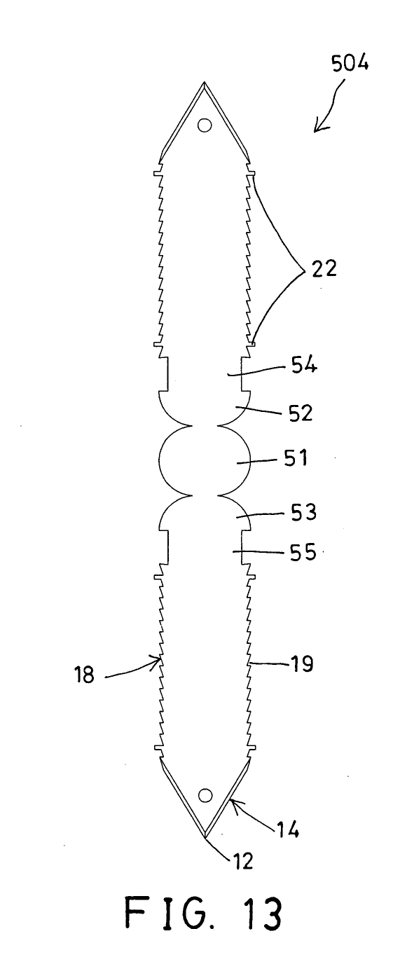

Alternatively, as shown in FIGS. 5-7, the coupling members 22 may be laterally extended from only one of the side portions of the planar element 11 of the fastener members 103 for coupling to the fastener members 103 together, and the coupling members 22 may either be laterally extended from one of the side portions of each of the longitudinal members 54, 55 of the planar member 501 (FIGS. 6, 7), or laterally extended from the side portion of only one of the longitudinal members 54, 55 of the planar member 502 (FIGS. 8, 9, 10, 11). The width, the shapes or the dimension of the planar member 503, 504 (FIGS. 12, 13) may be greater, smaller, or different from that of the other planar members 501, 502.

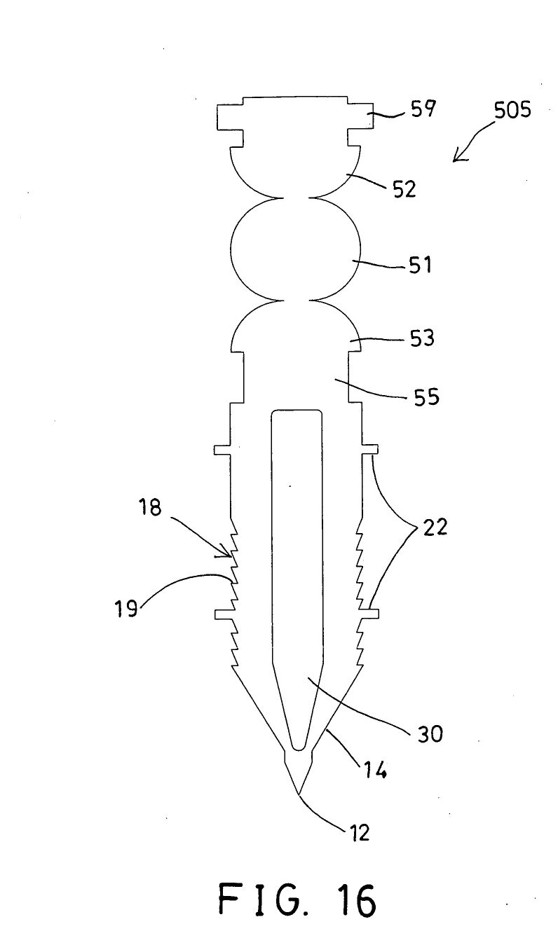

Further alternatively, as shown in FIGS. 16-24, the planar members 505, 506, 507, 508 may include a longitudinal member 55 extended from or coupled to only one of the panels 53, and no longitudinal member is extended from or coupled to the other panel 52, but may include one or more (such as two) anchoring or securing members 59 extended from the panel 53 and foldable or bendable to engage with the longitudinal member 55 and to solidly secure the panels 52, 53 to the intermediate board 51. The planar members 505, 506, 507, 508 may include one or more reinforcing protrusions or ribs 30,31, 32, 33 extended from one side of the longitudinal member 55 for forming a recess in the other side or the opposite side of the longitudinal member 55, and for reinforcing the fastener members and for preventing the fastener members from being easily bent or distorted, and also for allowing the fastener members to be effectively driven or engaged into or through the boards or plates.

Accordingly, the fastener device in accordance with the present invention includes a plate-shaped fastener device for engaging with the boards and for attaching or securing boards together or for attaching or securing boards to the other supporting objects or walls and for preventing the fastener device from being disengaged from the boards and/or the supporting objects or walls and for preventing the boards from being broken by the fastener device, and includes a reinforcing structure that may be easily and quickly manufactured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
a fastener member including a planar element having a cutting member provided on a lower portion thereof, and including a head provided on top of said planar element, and said planar element being formed with a planar member which includes an intermediate board having a shape corresponding to that of said head, and which includes two panels oppositely extended from said intermediate board and foldable relative to said intermediate board for engaging with said intermediate board and for forming said head of said planar element, and which includes a longitudinal member extended from a first panel of said panels.

2. The fastener device as claimed in claim 1, wherein said planar member includes a second longitudinal member extended from a second panel of said panels.

3. The fastener device as claimed in claim 2, wherein said planar element includes at least one coupling member extended from one side of said second longitudinal member of said planar member.

4. The fastener device as claimed in claim 1, wherein said planar element includes at least one coupling member extended from one side thereof.

5. The fastener device as claimed in claim 4 further a second fastener member including a second planar element having a cutting member provided on a lower portion thereof, and including a head provided on top of said planar element, and including at least one second coupling member extended from one side of said second planar element and detachably coupled to said at least one coupling member of said planar element.

6. The fastener device as claimed in claim 5, wherein a folding line is formed between said at least one coupling member of said planar element and said at least one second coupling member of said second planar element.

7. The fastener device as claimed in claim 1, wherein said panels each include a shape corresponding to one half of said intermediate board.

8. The fastener device as claimed in claim 1, wherein said fastener member includes a plurality of teeth extended from side portions of said planar element for anchoring purposes.

9. The fastener device as claimed in claim 8, wherein said teeth are ratchet teeth.

10. The fastener device as claimed in claim 1, wherein said fastener member includes at least one first reinforcing rib extended from said longitudinal member of said planar member.

11. The fastener device as claimed in claim 1, wherein said planar element includes at least one coupling member extended from one side of said longitudinal member of said planar member.
